(19) United States
(12) Patent Application Publication
(10) Pub. No.: US 2012/0261861 A1
(43) Pub. Date: Oct. 18, 2012

(54) Nano-Steel Reinforcing Fibers in Concrete, Asphalt and Plastic Compositions and the Associated Method of Fabrication

(76) Inventor: Paul E. Bracegirdle, Newtown, PA (US)

(21) Appl. No.: 13/170,889

(22) Filed: Jun. 28, 2011

Related U.S. Application Data
(60) Provisional application No. 61/359,314, filed on Jun. 28, 2010.

(51) Int. Cl. B29C 39/10; C08K 3/08; C04B 14/48

(52) U.S. Cl. 264/279; 106/644; 106/641; 106/640; 524/440; 524/441

(57) ABSTRACT

A metal fiber reinforced composition and its method of fabrication. Metal fibers are created by broaching or shaving metal wool from stock material. The wool is straightened and cut into short lengths. Each of the metal fibers has an average maximum diameter of between 0.005 millimeters and 0.2 millimeters, and a cut length no greater than two-hundred times the average maximum diameter. A volume of a curable composition is provided. The metal fibers are mixed into the curable composition to create a fiber reinforced composition. The fiber reinforced composition is then formed into a selected shape, such as a construction element. The selected shape is then cured. Since the metal fibers are dispersed uniformly throughout the selected shape, curing or re-heating of the selected shape can be facilitated using an induction coil that heats the various metal fibers within the selected shape.

### RELATED APPLICATIONS

This application is a continuation-in-part of co-pending provisional patent application No. 61/359,314, entitled, Making And Using Nano-Steel Fibers As Reinforcing Fibers In Concrete, Asphalt, and Plastic, filed Jun. 28, 2010.

### BACKGROUND OF THE INVENTION

1. Field of the Invention

In general, the present invention relates to systems and methods that are used to reinforce curable compositions, such as concrete, asphalt and plastic compositions used to create building materials. More particularly, the present invention relates to systems and methods that reinforce concrete, asphalt or plastic compositions with metal reinforcement elements.

2. Prior Art Description

Concrete and asphalt have been reinforced with metal rebar, and metal mesh for over two centuries. Similarly, many plastic compositions have been molded around metal reinforcements since the creation of moldable plastics. Such reinforcement schemes are well known. However, such reinforcement schemes share the same drawbacks. In all instances, the metal reinforcements must be provided in place and the concrete, asphalt, or plastic is molded or poured around metal reinforcement. As a consequence, if the concrete, asphalt, or plastic were to be poured or molded into a shape, the metal reinforcements had to be previously fabricated into the appropriate shape and set in a mold or form prior to the pouring of the curable composition. The creation of the metal reinforcement framework is often a highly skilled, labor intensive and costly part of the fabrication process. Furthermore, the metal reinforcement framework only provides strength reinforcement in the central areas of the fabrication that physically contain the metal reinforcements. Exterior portions of the fabrication and delicate extensions that may protrude from the fabrication do not benefit from the metal reinforcements because the metal reinforcement is not present within these regions.

In the prior art, many types of fibers have been added to concrete, asphalt and plastic in an attempt to reinforce structures made with such materials. For example, in U.S. Pat. No. 7,563,017 of Paul Bracegirdle, entitled, Process for Mixing Congealable Materials Such as Cement, Asphalt, and Glue with Fibers from Waste Carpet, recycled carpet fibers are used to reinforce concrete or asphalt. The fibers are mixed into the composition before the composition is poured. Consequently, the reinforcement fibers are distributed throughout the concrete or asphalt material. As such, every area of the poured concrete or asphalt receives some level of fiber reinforcement.

The problem with adding carpet fibers, glass fibers, or other such fibers to concrete, asphalt or plastic is one of strength. Glass and fiberglass fibers are brittle and do not withstand shear forces well. Plastic reinforcement fibers are flexible, but tend to creep over time if exposed to prolong periods of stress. Furthermore, steel fibers made from drawn steel wire or slit sheet steel are constricted by the method of manufacture and are too large, both in diameter and thickness to provide sufficient quantities in the composition to impart reinforcement throughout. All prior art steel fiber types rely on bent ends or shaped ends to minimize slippage and are subject to pull-out.

A need therefore exists for a system and method of reinforcing curable compositions, such as concrete, asphalt and plastic with reinforcement fibers that are as strong as steel, yet can provide a high fiber count per unit of volume and be evenly dispersed throughout the composition before the composition is poured, molded or cast. This need is met by the present invention as illustrated and described below.

### SUMMARY OF THE INVENTION

The present invention is a metal fiber reinforced composition and its method of fabrication. Metal fibers are created by broaching or shaving metal wool from stock material. The wool is worked to be straightened and is then rolled on spools for later use or cut into short lengths. Each of the metal fibers has an average maximum diameter of between 0.005 millimeters and 0.2 millimeters, and a cut length no greater than two-hundred times the average maximum diameter.

A volume of a curable composition is provided. The curable material can be a cementitious material or can alternately be asphalt of plastic based. The metal fibers are mixed into the curable composition to create a fiber reinforced composition. The fiber reinforced composition is then formed into a selected shape, such as a construction element. The selected shape is then cured.

Since the metal fibers are dispersed uniformly throughout the selected shape, curing or re-heating of the selected shape can be facilitated using an induction coil that heats the various metal fibers within the selected shape. The heating can be brought to extreme temperatures to increase the strength of the cured composition. In the asphalt or plastic based compositions the composition can be re-heated and reshaped.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of an overview of the present invention method of manufacture;

FIG. 2 shows a selected form fabricated using the methodology of FIG. 1 and the use of an option inductive heating system;

FIG. 3 is a schematic showing the methodology used to produce the metal nano-fibers; and

FIG. 4 is a schematic showing metal nano-fibers being used in a cementitious composition.

### DETAILED DESCRIPTION OF THE DRAWINGS

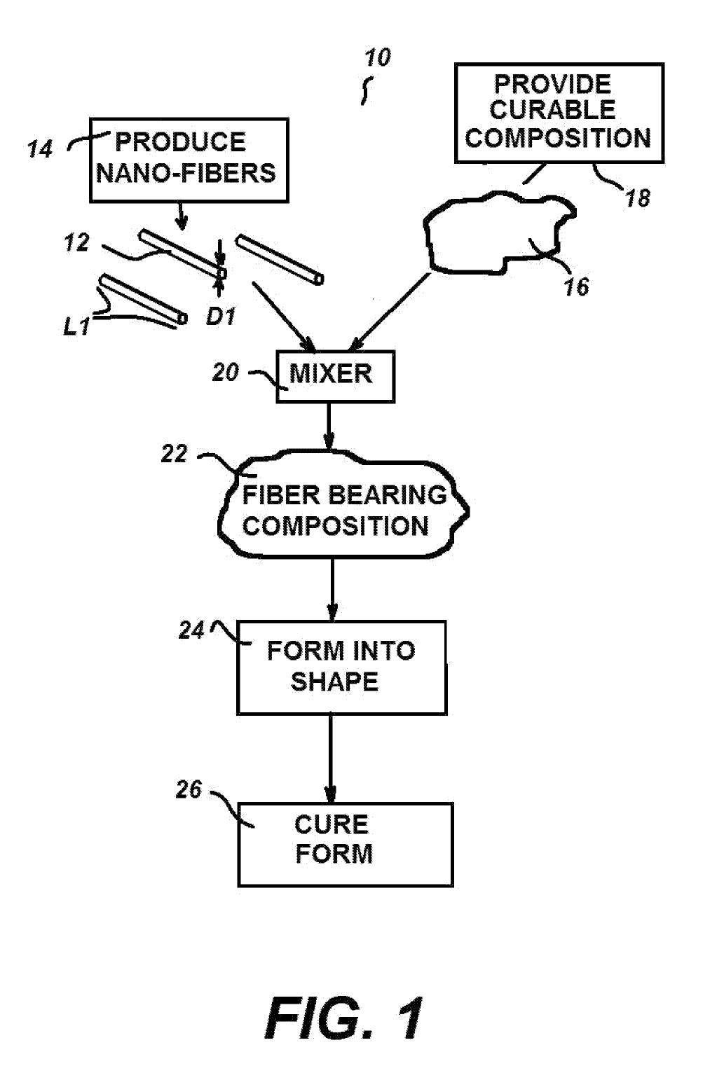

Referring to FIG. 1, an overview of the present invention is presented. In a first step, metal nano-fibers 12 are produced. See Block 14. The processes used to produce the metal nano-fibers 12 are later explained. The metal nano-fibers 12 are essentially straight segments of metal having an average diameter of between 0.2 millimeters and 0.005 millimeters. The preferred diameter range is between 0.18 millimeters and 0.004 millimeters.

The length L1 of each of the metal nano-fibers 12 should be proportional to its average maximum diameter D1. The preferred ratio of length-to-diameter is between 10:1 and 200:1. Accordingly, metal nano-fibers 12 that have an average maximum diameter D1 of 0.10 millimeters should have a length L1 of between 1 millimeter and 20 millimeters.

As will be later explained, each metal nano-fiber 12 is not a length of smooth wire. Rather, each length of metal nano-fiber 12 is textured with numerous peaks and valleys. Accordingly, the average maximum diameter D1 is used as the reference measurement. However, many points on each metal nano-fiber 12 may have a width smaller than the average maximum diameter D1.

The metal nano-fibers 12 are mixed with a curable composition 16 such as a concrete mix, an asphalt mix, or a plastic mix. Depending upon the density of the curable composition 16, the metal nano-fibers 12 are added into the mix in the preferred range of between 0.5 kilograms to 6 kilograms per cubic meter of concrete product and between 0.5 kilograms to 12 kilograms per cubic meter of asphalt or plastic products. See Block 18.

The metal nano-fibers 12 are mixed with the curable composition 16 in a mixer 20 before the curable composition 16 sets. The metal nano-fibers 12 can be added at any point in the preparation of the curable composition 16, provided the metal nano-fibers 12 are provided with the opportunity to spread throughout the curable composition 16 prior to solidification. For example, if a concrete composition is being prepared the metal nano-fibers 12 can be added with the aggregate before the introduction of water. Alternatively, the metal nano-fibers 12 can be added to the mix after water has been introduced but before the concrete begins to cure.

The metal nano-fibers 12 are so small in size that they do not settle to the bottom of the curable composition 16. Rather, the metal nano-fibers 12 remain uniformly dispersed throughout the curable composition 16. Furthermore, the metal nano-fibers 12 are oriented in every possible direction within the curable composition 16.

After the metal nano-fibers 12 have been added into the mixer 20 and mixed with the curable composition 16, a fiber bearing composition 22 is created. The fiber bearing composition 22 is then formed into a selected shape. See Block 24. This is typically accomplished by pouring the fiber bearing composition 22 into a form or mold. However, plastic-based compositions may be extruded or even injection molded.

After the formation process, the form is permitted to cure. See Block 26. As will be later explained, since the metal nano-fibers 12 are dispersed throughout the form, curing or subsequent re-heating can be induced through the use of inductive heating.

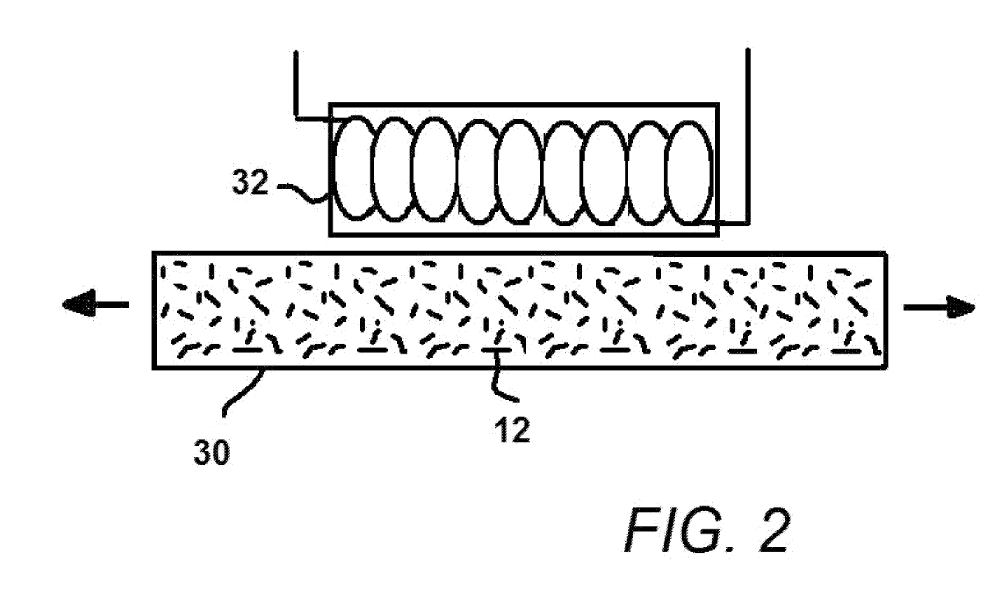

Referring now to FIG. 2, a formed concrete building element 30 has been poured. The formed concrete building element 30 contains the metal nano-fibers 12 in the size and quantity previously described. The formed concrete building element 30, therefore, has metal nano-fibers 12 uniformly dispersed throughout the formed concrete building element 30. The metal nano-fibers 12 mechanically reinforce the formed concrete building element 30 by providing flexible reinforcement fibers that do not creep over time. Furthermore, by dispersing metal nano-fibers 12 throughout the formed concrete building element 30, the formed concrete building element 30 can be heated using induction. When the formed concrete building element 30 is heated, two processes occur. First, the formed concrete building element 30 cures much faster than it would otherwise. Secondly, if the formed concrete building element 30 sufficiently heated, the strength of the concrete mixture increases dramatically over that of the formed concrete building element 30 left to cure in ambient conditions. Furthermore, by using inductive heating, the formed concrete building element 30 can be heated at controlled temperatures and temperature change rates in order to assure that curing occurs quickly, uniformly and without any stress cracks.

The inductive heating of the formed concrete building element 30 is created by bringing at least one induction coil 32 into close proximity with or surrounding the formed concrete building element 30. The induction coil 32 induces heat in the metal nano-fibers 12. The heat from the metal nano-fibers 12 heats the concrete material surrounding the metal nano-fibers 12. The inductive heating can be performed on-site by pouring the formed concrete building element 30 on site and then moving an induction coil 32 over the poured concrete. However, for concrete building elements 30 that are formed in a factory, the inductive heating and curing of the formed concrete building element 30 occurs at the factory. In a factory, the formed concrete building element 30 can be placed in a vacuum chamber or inert gas chamber prior to inductive heating. In such an environment, heating to temperatures in excess of 400 degrees Celsius can be achieved without surface oxidation.

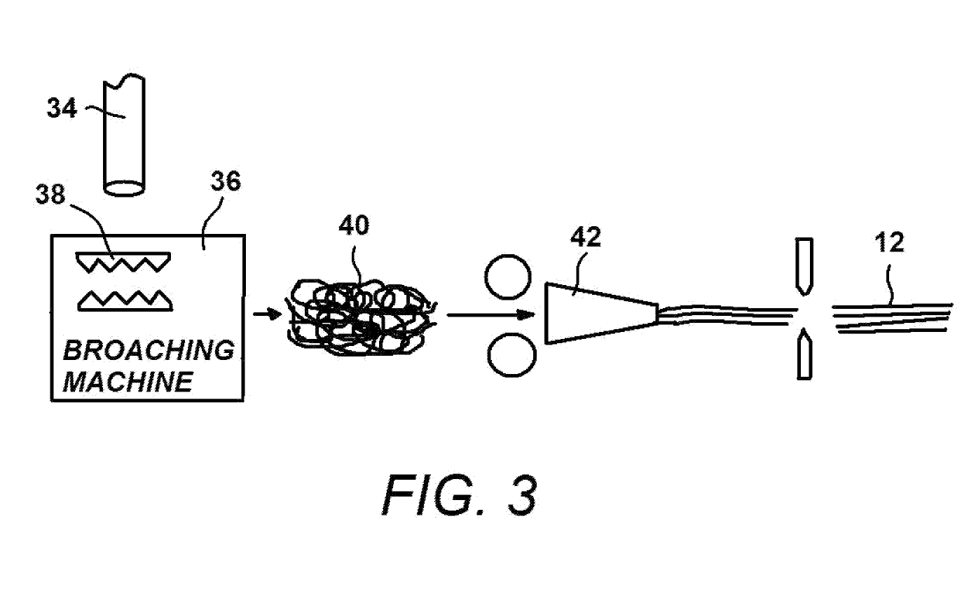

Referring now to FIG. 3, the method of manufacturing the metal nano-fibers 12 is illustrated. Metal wire 34 is introduced into a metal broaching or shaving machine 36. The metal broaching machine 36 has teeth 38 that cut into the wire 34 and peels away coarse curly strands of metal wool 40. The metal wire 34 can be made from a variety of metals and alloys, such as iron, stainless steel, titanium and the like. The preferred metal wire 34 is steel. Accordingly, the metal wool 40 being produced is steel wool.

The curly strands of metal wool 40 are collected. The maximum diameter of the curly strands is determined by the teeth 38 within the broaching or shaving machine 36. The teeth 38 are selected to create curly strands of fibers having a maximum diameter D1 in the range previously stated.

The broaching machine 36 produces metal wool 34. Metal wool 34 cannot be directly used as metal nano-fibers 12. If metal wool 40 were just added to concrete, asphalt, or plastic, the curable composition would simply form around the clump of metal wool 40.

The individual fibers of the metal would not disperse because they are entangled with one another. As a result, metal wool 40 added to such a curable composition would actually weaken the composition by creating clumped flaws of wool within the composition.

To convert the curly metal wool 40 into usable nano-fibers 12, the metal wool 40 is gathered and drawn through a compression or straightening die 42. The compression die 42 can be a series of rollers, a funnel reducer, or another such die head that compresses or shapes the metal wool 40 as it is being drawn. As the metal wool 40 is drawn, it experiences tensile forces that stretch the curly metal wool 40 into generally straight lengths. Simultaneously, the curly metal wool 40 is being compressed so that the metal wool 40 loses its memory and remains straight even after the tensile force ceases.

Once the steel wool has been straightened, it is coiled for later use or cut into the stated fiber lengths. The nano-fibers 12 are then packaged and stand ready for use with a curable composition.

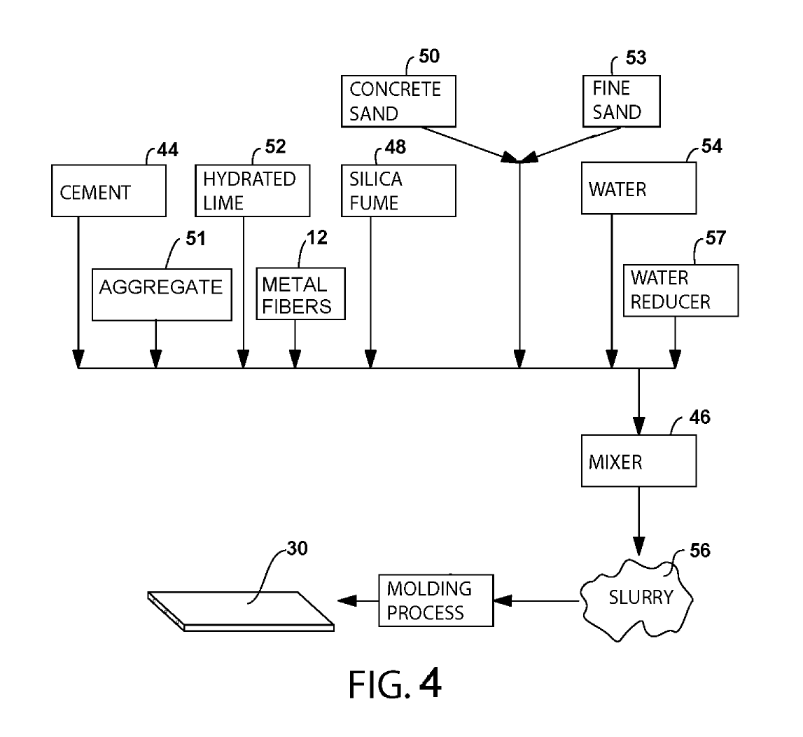

Referring to FIG. 4, an exemplary curable composition 16 is presented. The curable composition 16 is comprised primarily of cementitious material 44. The cementitious material 44 can be type “1”, type “2” and/or type “3” cement. Other variations of cement products such as type “K” or even ultra-high-strength cementitious materials may also be used. More eco-friendly, environmentally sustainable pozzolans or cement-like products such as fly ash or finely ground slag may be used as well. The cementitious material 44 is added into a mixer 46 in amounts between 400 and 900 pounds per cubic yard. To help the cementitious material 44 cure with proper strength, silica fume 48 and fine aggregate are added to the mixer 46. The fine aggregate may be a blend of concrete sands 50 and/or lightweight small aggregate 51. Hydrated lime 52 may be added in amounts approximately 40 to 80 pounds per cubic yard. The silica fume 48 may be added in amounts between 40 and 80 pounds per cubic yard. Concrete sand 50 and/or lightweight fine aggregate 51 is added at a concentration of between 300 and 500 pounds per cubic yard. Secondary sands or fine aggregate 53 are added between 400 and 600 pounds per cubic yard.

To increase the flexibility, strength and toughness of the curable composition 16, metal nano-fibers 12 are added into the mixer 46 in the amounts previously stated.

Water 54 is added to the mixture to produce moldable uncured slurry 56. Approximately, 200 to 350 pounds of water 54 per cubic yard will produce the needed consistency and proper water-cement or water-pozzolan ratio. A water reducing admixture 57 can be added to the mixture to ensure more even mixing and improve flow. Other admixtures such as accelerators, retarders, and air entraining agents may be added to improve performance for the casting operations and other methods that may be used to form such synthetic building products.

Once all the ingredients are added into the mixer 46, the uncured slurry 56 is mixed to the proper consistency prior to the uncured slurry 56 being directed into a mold. Depending upon the amount of water 54 or water reducer 57 used in the uncured slurry 56, the uncured slurry 56 can be produced as thin slurry or even a self-consolidating mix, suitable for pour molding techniques. The uncured slurry 56 is then either allowed time to cure or is actively heated by induction to reduce curing time. The final result is building materials, such as piers, columns, crossbeams and decking channels or tees, made from the curable composition 16.

Asphalt based compositions and plastic based compositions can be fabricated in manners similar to the cementitious composition. However, in asphalt-based compositions and plastic based compositions, the end product need not be cast or poured immediately. Rather, asphalt-based compositions and plastic based compositions can be created and the stored as stock material. When needed to create a product, the asphalt-based material or plastic based material can then be heated using inductive heating or other heating methods to a point where the composition again becomes malleable. The soft asphalt or plastic can then me poured or molded into a desired shape or product.

It will be understood that the embodiments of the present invention that are shown are merely exemplary and that a person skilled in the art can make many variations to those embodiments. For instance, the present invention can be made into many formed concrete building element, such as building and framing lumber, posts, and railings, in addition to decking piers, beams and decking tees. Furthermore, additives, such as colorants, mold inhibitors, crystalline admixtures, and the like can also be added to the disclosed compositions. Moreover, other methods of similar composition manufacturing techniques, such as dry-pack methods, in-situ pre-casting and sawn in-place products may be employed. All such variations, modifications and alternate embodiments are intended to be included within the scope of the present invention as defined by the claims.

What is claimed is:

1. A method, comprising the steps of:
providing metal fibers, wherein each of said metal fibers has an average maximum diameter of between 0.005 millimeters and 0.2 millimeters, a length no greater than two-hundred times said average maximum diameter, and a roughened exterior created by broaching;
providing a volume of a curable composition;
mixing said metal fibers into said curable composition to create a fiber reinforced composition;
forming said fiber reinforced composition into a selected shape; and
curing said fiber reinforced composition into said selected shape.

2. The method according to claim 1, wherein said length of said metal fibers is no less than ten times said average maximum diameter.

3. The method according to claim 1, wherein said curable composition is selected from a group consisting of concrete, asphalt and plastic.

4. The method according to claim 1, wherein said step of providing a volume of metal fibers includes providing a volume of steel fibers.

5. The method according to claim 1, wherein said step of mixing including uniformly dispersing said metal fibers throughout said curable composition.

6. The method according to claim 1, wherein said step of curing said fiber reinforced composition includes heating said selected shape.

7. The method according to claim 6, wherein said step of heating said selected shape includes positioning said selected shape proximate an induction coil, wherein said induction coil heats said metal fiber elements in said selected shape.

8. The method according to claim 1, wherein said curable composition is a cementitious composition.

9. The method according to claim 8, wherein said step of mixing includes mixing between 0.5 kilograms and 12 kilograms of metal fibers per cubic meter of curable composition.

10. A method of reinforcing a curable composition with metal fibers, comprising the steps of:
cutting curly wool from stock metal;
straightening said curly wool into generally straight lengths;
cutting said lengths into fibers;
mixing said fibers with a curable composition so that said fibers are uniformly dispersed throughout said curable composition;
forming said curable composition; and
curing said curable composition.

11. The method according to claim 10, wherein said stock metal is selected from iron, steel, stainless steel, titanium, aluminum and alloys thereof.

12. The method according to claim 10, wherein each of said metal fibers has an average maximum diameter of between 0.005 millimeters and 0.2 millimeters, a length no greater than two-hundred times said average maximum diameter, and a roughened exterior created by said step of cutting;

13. The method according to claim 12, wherein said lengths of said metal fibers is no less than ten times said average maximum diameter.

14. The method according to claim 10, wherein said curable composition includes cementitious material.

15. The method according to claim 10, wherein said step of curing said curable composition includes heating or re-heating said curable composition.

16. The method according to claim 15, wherein said step of heating includes positioning said curable composition proximate an induction coil, wherein said induction coil heats or re-heats said metal fiber in said selected shape.

17. The method according to claim 10, wherein said step of mixing includes mixing between 0.5 kilograms and 12 kilograms of metal fibers per cubic meter of curable composition.

18. A method of fabricating a fiber reinforced cementitious composition, comprising the steps of:
creating metal fibers having an average maximum diameter of less than 0.2 millimeters and a length less than two-hundred times said average maximum diameter;
mixing said metal fibers with said cementitious composition, wherein said metal fibers become uniformly dispersed throughout said cementitious composition; and
curing said cementitious composition.

19. The method according to claim 18, wherein said step of creating metal fibers includes the substeps of broaching metal wool from stock material,
straightening said metal wool and cutting said metal wool into fibers.

20. The method according to claim 18, wherein said metal fibers have and average maximum diameter under 0.2 millimeters and an average length no greater than two-hundred times said average maximum diameter.

21. A method of fabricating a meltable fiber reinforced composition, comprising the steps of:
providing a meltable composition, selected from a group consisting of plastic compositions and asphalt compositions;
creating metal fibers having an average maximum diameter of less than 0.2 millimeters and a length less than two-hundred times said average maximum diameter;
heating said meltable composition and mixing said metal fibers with said meltable composition, wherein said metal fibers become uniformly dispersed throughout; and
shaping said meltable composition into a preselected form.
